(19) United States
(12) Patent Application Publication
(10) Pub. No.: US 2004/0115417 A1
(43) Pub. Date: Jun. 17, 2004

(54) Method for the production of a fire-protection panel

(76) Inventors: Marco Fischer, Kaufering (DE); Herbert Munzenberger, Wiesbaden (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/653,642

(22) Filed: Sep. 2, 2003

(30) Foreign Application Priority Data
Sep. 3, 2002 (DE) 102 40 522.0

(51) Int. Cl. B32B 3/26; B32B 27/12; B32B 27/30

(52) U.S. Cl. 428/304.4; 442/396

(57) ABSTRACT

The method of producing an organically bound, flexible fire-protection panel with a low density, inorganic filler (12) includes introducing a predetermined amount of a foamable organic binder matrix (5) into a mold (1), which is formed as a panel mold, and distributing the organic binder matrix (5) uniformly over the bottom (2) of the mold (1). Subsequently, the mold (1) is filled completely with an adequate amount of the inorganic filler (12), and as the mold (1) is being closed with a lid (16), the volume of the interior of the mold (1) is reduced and the inorganic filler (12) is pressed into the organic binder matrix (5), and then the organic binder matrix (5) is foamed.

### BACKGROUND OF THE INVENTION

1. Field of Invention The present invention relates to a method of production of an organically bound, flexible fire-protection panel with an inorganic filler as well as to a fire-protection panel.

2. Description of the Prior Art

Foamed organic polymer products are to be found in very many areas of daily life. Open-pored flexible foams are used, for example, for mattresses or automobile seats. Integral foams are used, for example, for automobile cockpits, furniture back rests and armrests or as damping elements for automobile bumpers. In the building sector, foamed organic polymer products find use as in situ-produced foams, as seals for joints or as insulation panels.

It is a disadvantage of the known solution that the foamed products cannot be used in the area of passive fire protection because of the limited fire resistance capability shown in the DIN 4102, part 9 and 11, fire test. It is now known that a plate material, which has the requisite fire resistance capability, can be produced from an organic matrix material and an inorganic filler. However, such a material has a high-density and poor insulation properties. The known method of producing the panel material is based on a prior mixing process, such as kneading, stirring, extruding, etc., and a subsequent consolidation and drying step. If now a light, foam-like, inorganic filler is used to produce the panel material, it can easily be destroyed by the known methods.

In the area of PUR reaction injection molding, technologies have become known, for which the filler is mixed homogeneously with the organic matrix by a continuous injection process in a mixing head. It is a disadvantage of these technologies that a ratio by volume of filler to PUR system of greater than 1 can no longer be processed. Moreover, the filler, which is to be mixed, must have a sufficient compressive strength and a filler, with a density less than 0.4 g/cc, as well as with a diameter in the millimeter range cannot be used.

Accordingly, an object of the invention is a method of producing a fire-protection panel, which has a large proportion by volume of a light, foam-like, inorganic filler, which is distributed homogeneously in an organic binder.

### SUMMARY OF THE INVENTION

This and other objects of the present invention, which will become apparent hereinafter, are achieved by a method of producing an organically bound, flexible fire-protection panel with an inorganic filler which comprises the following steps:

In a first step, a defined amount of a foamable, organic binder matrix is introduced, optionally by a metering system, into a mold, which is constructed as a panel mold. The mold preferably has a basic rectangular shape and comprises a bottom, as well as side walls surrounding the bottom. The height of the side walls is greater than the thickness of the fire-protection panel, which is to be produced. The organic binder matrix comprises several components, which preferably are mixed in the desired ratio before they are introduced into the mold. To ensure a constant quality of several fire-protection panels, produced by the inventive method, the organic binder matrix preferably is filled into the mold by means of a metering system.

In a second step, the organic binder matrix is distributed uniformly over the bottom of the mold, so that the thickness of the layer of organic binder matrix is the same over the whole of the bottom.

Subsequently, the mold is filled with an adequate amount of an inorganic filler. The ratio by volume of inorganic filler to organic binder matrix is about 9:1. The organic binder matrix mainly is intended to glue the particles of the inorganic filler. In addition, the organic binder matrix functions to configure the surface of the panel optimally. The amount of inorganic filler must be such that it fills the mold completely as a loose filling. Since the side walls of the mold are higher than the thickness of the panel, which is to be produced, the mold can be filled uniformly up to the upper edge.

In the next step up of the inventive method, the mold is closed off with a lid, the volume of the interior of the mold being reduced. The lid is provided with an insert which, when the lid is closed, pushes the inorganic filler into the organic binder matrix, without pressing the latter to such an extent, that it is destroyed.

In the next step, the organic binder matrix is foamed. The composition of the organic binder matrix is selected so that it can be foamed chemically or physically. The foaming reaction is adjusted by means of catalysts, so that sufficient time remains for metering the inorganic filler completely into the mold, and so that the completely foamed fire-protection panel can be removed from the mold as quickly as possible.

Subsequently, the mold is opened and the finished fire-protection panel can be removed.

The inventive method is not preceded by a mechanical mixing process, which can destroy the preferably light, foam-like, inorganic filler and thus increase the density of the fire-protection panel. Furthermore, the inorganic binder matrix has a relatively high viscosity ranging from 1000 to 5000 mPas, which, with the mechanically stable character of the inorganic filler, makes a prior mixing process impossible. The fire-protection panel, which is produced by the inventive method, accordingly has a low density and provides a good insulation effect. At the same time, the fire-protection panel, produced with the method, has a fire resistance capability, which meets the requirements of the Standard, and can easily be processed. The fire-protection panel, produced with this method, can be used, for example, for fireproofing installation openings through fire-proof walls. Since there is no intumescent process, the function of the fire-protection panel is provided only by the fire-resistant construction.

Preferably, for controlling the foaming of the organic binder matrix, the mold is tempered. Tempering the mold offers different possibilities for optimizing the reaction time of the foaming process and is carried out, for example, by means of an electrical heating device or by means of a suitable cooling device. For controlling and accelerating the reaction, the mold is held at a temperature below 100° C. and preferably at a temperature of 40° to 50° C.

Preferably, a polymer, particularly a polyurethane or phenolic resin is used as binder matrix. The polyol component of the organic binder matrix may be provided with the following fillers: acid-forming agents, flame retardants, ash crust stabilizers and fillers, forming micropores and sensitive to high temperatures. As acid-forming agents, for example, a salt or an ester of an inorganic, non-volatile acid is used and selected from phosphoric acid or boric acid. Ammonium phosphate, ammonium polyphosphate, diamine phosphate, melamine borate, boric acid esters and the like are preferred. As flame retardants, a halogen-containing phosphate ester, for example, is used. As ash cnist stabilizer, an oxide or a compound of a metal such as aluminum, magnesium, iron and zinc is used. Iron oxide, iron trioxide, titanium oxide or a borate, such as zinc borate, are preferred. As filler, forming micropores and sensitive to high temperatures, inorganic, hollow microspheres, such as aluminum silicate spheres, glass spheres or fly ash spheres with particle sizes ranging from 50 μm to 500 μm, for example, are used.

Preferably, before the organic binder matrix is introduced and/or after the organic binder matrix is introduced and/or after the mold is filled with inorganic filler, a woven, knitted or nonwoven mat is placed in the mold. Such a mat increases the mechanical stability of the fire-protection panels produced, without significantly affecting the ability to cut the fire-protection panels. If the mat is placed in the mold before the organic binder matrix is introduced and/or after the mold is filled with organic filler, the finished fire-protection panel produced has one or two homogenous surfaces. The mat may, for example, be a mat woven from glass fibers or from coated and uncoated silicate fibers. Moreover, it is conceivable to use a knitted wire, wire netting or a wire screen.

Pursuant to the invention, an organically bound, flexible fire-protection panel comprises an inorganic filler, the latter having a specific density of less than 0.4 g/cc. With the low density of the inorganic filler, the fire-protection panel has a good insulation value. High temperature-resistant filler particles, such as light, incombustible, inorganic materials, such as perlite, expanded vermiculite and the like are used as inorganic filler.

Preferably, the inorganic filler is a porous material, which has an irregular particle size and shape, the particle size being 0.1 mm to 10.0 mm and optionally 1.0 mm to 6.0 mm. The concept of an irregular particle size means that several particles together cover the whole of the aforementioned size range. An irregular particle shape is understood to mean all three-dimensional spatial shapes, which the inorganic filler can have during its production. Aside from a spherical configuration, the particles may be polyhedral. Since the production of the fire production panel does not involve a mechanical mixing process and the light, foam-like, inorganic filler is merely foamed by the organic binder matrix, the particle size and shape of the inorganic filler is largely retained. The fire-protection panel has a homogeneous structure.

Preferably, the foamable, organic binder matrix comprises a polymer, optionally a polyurethane or a phenolic resin.

Advantageously, the fire-protection panel has at least one woven, knitted or nonwoven mat. The mat may be disposed at the surfaces and/or in the fire-protection panel. Preferably, a woven, knitted or nonwoven mat is used, which is difficult to ignite.

The novel features to the present invention, which are considered as characteristic for the invention, are set forth in the appended claims. The invention itself, however both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

In the Drawings:

FIG. 1 shows a schematic cross-sectional view illustrating the introduction and distribution of the organic binder matrix;

FIG. 2 shows a schematic cross-sectional view illustrating the filling of the mold with an inorganic filler;

FIG. 3 shows a cross-sectional view of the closed mold;

FIG. 4 shows a cross-sectional view of the mold with the foaming process of the inorganic binder matrix; and

FIG. 5 shows a cross-sectional view illustrating the opening of the mold and the removal of the fire-protection panel, which has been produced according to the inventive method.

### DETAILED DESCRIPTION OF THE PREFERRED EMBODIMENT

In the drawings, the identical parts are designated with the same reference numerals.

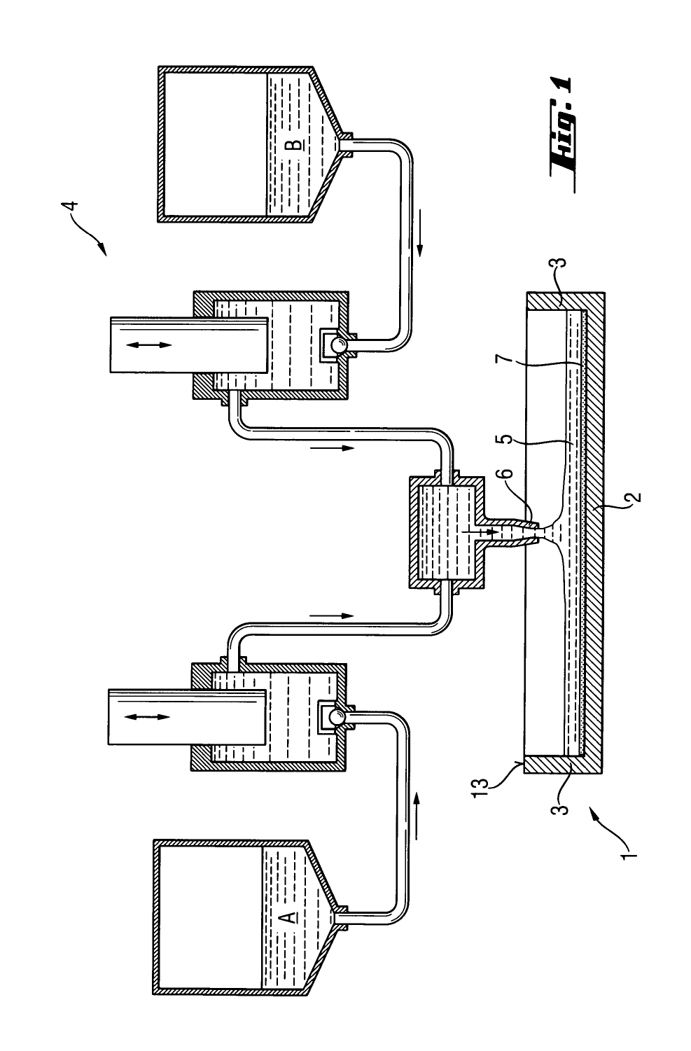

The individual process steps of the method of producing a fire-protection panel are shown in FIGS. 1 to 5. In FIG. 1, the first step of the process is shown. The mold 1 for producing a panel-shaped fire-protection panel by the inventive method has an essentially rectangular configuration with a length, a width and a height. The mold 1 comprises a bottom 2 and side walls 3, which are higher than the thickness of the finished fire-protection panel. A defined amount of a foamable, organic matrix binder 5 is introduced from a metering system 4. The organic binder matrix consists of several components. In this example, reference is made to two components A and B as being representative of all the components of the organic binder matrix. The components A and B are mixed to form an organic binder matrix 5 using a standard method for metering a two-component system. Before the organic binder matrix 5 is filled into the mold 1, a glass fiber fabric 7 is placed on the bottom 2 of the mold 1 in order to improve the mechanical properties of the fire-protection panel. Subsequently, the mixed organic binder matrix 5 is supplied to the mold 1 over the nozzle 6 and distributed uniformly over the bottom 2.

The next step of the method is shown in FIG. 2. The mold 1 is filled from a storage tank 11 up to the upper edge 13 of the side walls 3 with an inorganic filler 12. The foaming reaction of the organic binder matrix 5 is adapted so that there is sufficient time for metering of the whole of the inorganic filler 12.

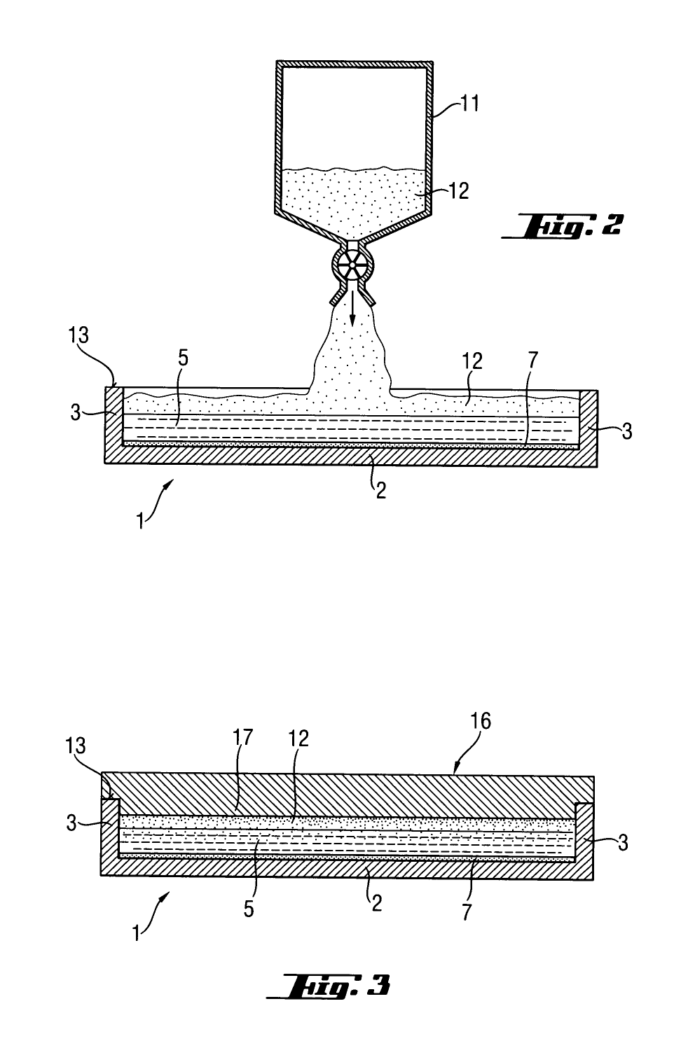

The closed mold 1 is shown in FIG. 3. The lid 16 for closing the mold 1 has an insert 17. The lid 16 is constructed in such a manner that the space between the upper edge of the bottom 2 and the lower edge of the lid 16, when the mold 1 is closed, corresponds to the height of the fire-protection panel, which is to be produced. When the mold 1 is closed with the lid 16, the volume of the interior space of the mold 1, which previously was open, is decreased. At the same time, the inorganic filler 12 is pressed into the organic binder matrix 5, but not so strongly, that it is destroyed.

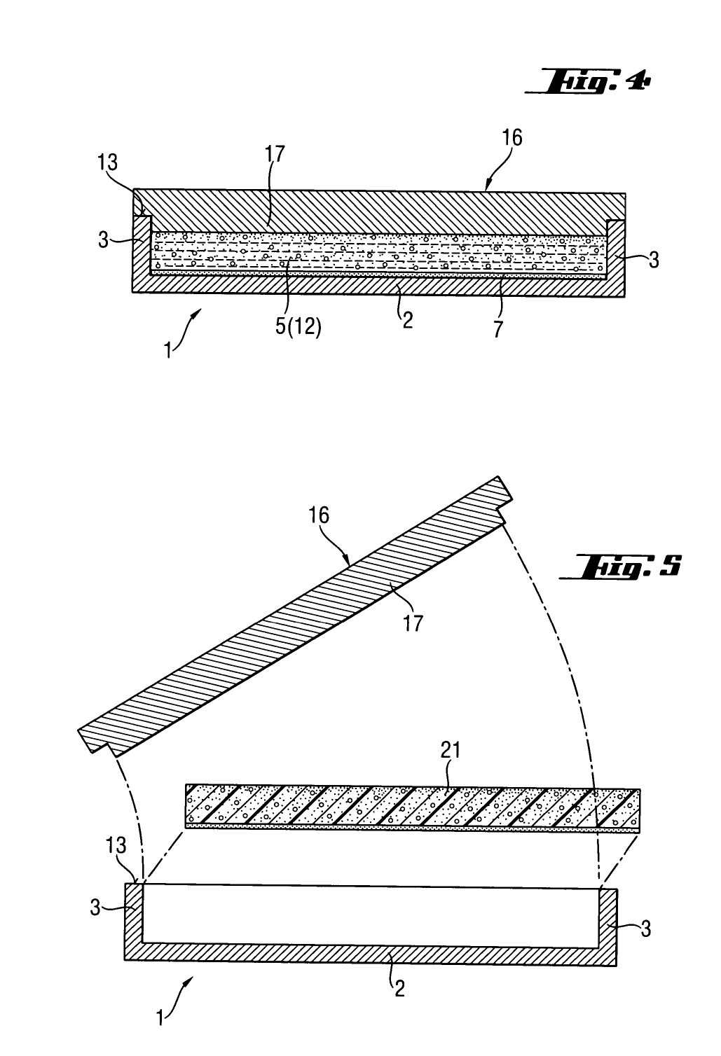

In FIG. 4, the foaming process of the organic binder matrix 5 is shown. After the mold 1 is closed, the foaming process of the organic binder matrix 5 is commenced. At the same time, the foamed, organic binder matrix penetrates into the hollow spaces between the individual particles of the organic filler 12 largely without destroying the latter. The reaction time of the foaming process of the organic binder matrix 5 can be optimized variably by tempering the mold 1.

FIG. 5 shows the opening of the mold and the removal of the fire-protection panel, produced according to the inventive method. After the foaming process of the organic binder matrix 5 is concluded, the mold 1 is opened by removing the lid 16 and the finished fire-protection panel 21 is removed from the mold 1.

To summarize, it may be noted that, with the inventive method, a fire-protection panel was created which, despite optimization of the physical properties in relation to density and insulating effects while, at the same time, being fire resistant and easily manufactured, contains a large proportion by volume of a light, foam-like inorganic filler, which is distributed homogeneously in the organic binder. The inventive fire-protection panel does not contain any intumescent materials.

Though the present invention was shown and described and references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is clamed is:

1. A method of producing an organically bound, flexible, fire-protection panel (21) with an inorganic filler (12), comprising the steps of:
a) introducing a predetermined amount of a foamable organic binder matrix (5) into a mold (1), which is formed as a panel mold;
b) uniformly distributing the organic binder matrix (5) over a bottom (2) of the mold (1);
c) filling the mold (1) with an adequate amount of an inorganic filler (12);
d) closing the mold (1) with a lid (16), whereby a volume of an interior space of the mold (1) is reduced,
e) foaming the organic binder matrix (5); and
f) opening the mold (1) and removing the fire-protection panel (21).

2. The method of claim 1, wherein the introducing step includes using a metering system for introducing the organic binder matrix (5).

3. The method of claim 1, wherein the mold (1) is tempered in order to control the foaming of the organic binder matrix (5).

4. The method of claim 1, wherein a polymer, is used as the organic binder matrix (5).

5. The method of claim 4, wherein the polymer is selected from a group consisting of polyurethane and phenolic resin.

6. The method of claim 1, wherein a woven, knitted or nonwoven mat is placed in the mold (1) at least one before the organic binder matrix (5) is introduced, after the organic binder matrix (5) is introduced, and after the mold (1) is filled with the inorganic filler (12).

7. An organically bound, flexible fire-protection panel (21) comprising a foamed organic binder matrix (5); and an inorganic filler (12) distributed in the foamed organic binder matrix, the inorganic filler (12) having a specific density of less than 0.4 g/cc.

8. The fire-protection panel of claim 7, wherein the inorganic filler (12) is a porous material and has an irregular particle size and shape, the particle size ranging from 0.1 mm to 10.0 mm.

9. The fire-protection panel of claim 8, wherein the particle size ranges from 1.0 mm to 6.0 mm.

10. The fire-protection panel of claim 5, wherein the foamable, organic binder matrix (5) comprises a polymer.

11. The fire protection panel of claim 10, wherein the polymer is selected from a group consisting of polyurethane and phenolic resin.

12. The fire-protection panel of claim 5, wherein the fire-protection panel comprises at least one of woven, knitted mat and nonwoven mat.
